(19) United States
(12) Patent Application Publication
(10) Pub. No.: US 2005/0136884 A1
(43) Pub. Date: Jun. 23, 2005

(54) Data transport to mobile devices using a radio broadcast data channel

(75) Inventors: Achim Reidelsturz, Wulfrath (DE); Torsten Musiol, Ratingen (DE)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/777,660

(22) Filed: Feb. 13, 2004

(30) Foreign Application Priority Data
Dec. 17, 2003 (EP) 03028944.1

(51) Int. Cl. H04M 11/00

(52) U.S. Cl. 455/403

(57) ABSTRACT

The present invention relates to method and system for providing data services to mobile device (25) via a digital radio broadcast channel, wherein data is encrypted and forwarded to a digital radio broadcast domain based on a conditional access scheme. The additional access scheme is based on existing concepts of SIM/IMSI definition and algorithms. The invention enables initial message coverage for developing countries and extends rural message coverage for huge area countries, where little mobile coverage is provided.

### FIELD OF THE INVENTION

The present invention relates to a method, system, cellular receiver device, server device, gateway device, and computer program product for enabling data transmission from a data source to a cellular receiver device, such as a second generation or third generation mobile device.

### BACKGROUND OF THE INVENTION

Outside the coverage area of mobile networks, so far no option exists to provide access to data or message services of the mobile network. In view of this, additional devices have to be used for receiving some poor information with restrictions regarding propagation characteristics and data safety. Even bulky satellite phones have to be used for full-duplex communication at extremely expensive service fees, huge power consumption and requiring a direct air-link to the sky.

Current mobile devices are often equipped with a FM (Frequency Modulation) radio receiver, as listening to the favorite radio station is an interesting add-on feature which attracts people to buy such a kind of phone even at higher costs. Outside the mobile network these enhanced mobile devices can only be used to listen to radio broadcast programs but cannot receive any mobile messages transmitted from the mobile network.

FIG. 1 shows a schematic diagram of a conventional radio network environment with an FM radio broadcast domain 10 and a mobile operator domain or mobile network 40. A mobile device 25 such as a mobile station or user equipment (in third generation (3G) terms) may receive radio signals from the FM radio broadcast domain 10 using its FM radio receiver, or from the mobile network 40 using its cellular radio receiver. As long as the mobile device 25 is in the coverage area of the mobile network 40, it has full access to all the related services, i.e. 2^{nd} generation (2G) and 3^{rd} generation (3G) services, provided by the mobile network 40 as indicated by the arrow \mathring{4}. In addition, if the mobile device 25 has a built-in FM radio receiver, it can receive FM radio broadcast programs, i.e. listen radio, broadcast by an FM radio transmitter 102 based on information supplied from an FM radio content server 104. In particular, the FM radio content server 104 receives audio streams A, traffic information Tr, news information N, and station/song information S. However, there is no access to the 2G/3G related services like messages at all, as there exists no concept to transfer those messages via e.g. old-fashioned analogue FM radio channels as indicated by the arrow \mathring{3}.

FIG. 2 shows a schematic diagram indicating service linkage within the above domains. In the mobile coverage area (MC) of the mobile network 40, IP services from the Internet, POTS (Plain Old Telephone System) services, and ISDN (Integrated Services Digital Network) services can be received via a mobile physical transport service backbone MPTB and can be forwarded as mobile data MD or mobile voice MV to a mobile physical transport service MPTC of the consumers which can be accessed by the mobile device 25. The forwarding of mobile voice or mobile data may be based on mobile databases 27, such as subscriber databases (e.g. Home Location Register (HLR) or Visitor Location Register (VLR)) to obtain required information about the mobile device 25. On the other hand, in the region OMC outside the coverage of the mobile network 40, an FM radio broadcast service FMRB is provided by which audio broadcast AB or data broadcast DB are provided, wherein the audio broadcast AB may be based on information obtained from IP networks such as the Internet. However, messaging services are not available outside the mobile coverage. Here, data receipt is only possible based on the data broadcast functionality, as indicated by the arrow \mathring{3}.

FIG. 2 thus shows the same situation as FIG. 1, but from a more functional point of view, and here it can be clearly recognized that outside the coverage of a mobile network, currently the mobile device 25 can only receive FM radio stations as indicated by the arrow \mathring{2}, while the data broadcast service is not connected to the mobile operator domain at all. When the mobile device 25 is located within the mobile coverage MC, it may still listen to the FM radio broadcast program as indicated by the arrow \mathring{1}.

As can be gathered from FIGS. 1 and 2, a communication barrier with respect to mobile data services is provided between the mobile coverage area MC and the area OMC outside the mobile coverage.

### SUMMARY OF THE INVENTION

It is therefore an object of the present invention to provide an improved data transmission scheme, by means of which mobile messages or mobile data services can be received by a mobile device even outside the coverage of a mobile network.

This object is achieved by a cellular receiver device for receiving data from a data source, said receiver device comprising:
cellular receiving means for enabling receipt of said data from a cellular network domain; and
radio broadcast access means for providing conditional access to a digital radio broadcast data channel to enable receipt of said data via said digital radio broadcast data channel.

Furthermore, the above object is achieved by a server device for providing a data service to a mobile device, said server device comprising:
gateway means for receiving data from an external data source and for mapping a destination address of said received data to a mobile subscriber identity of said mobile device; and
adding means for adding said mobile subscriber identity to said received data and for putting said received data with said mobile subscriber identity to a data stream to be broadcast via a digital radio broadcast channel.

Additionally, the above object is achieved by a gateway device for providing a connection between a cellular network and a digital radio broadcast domain, said device being configured to encrypt data received from said cellular network to be forwarded to a mobile device, and to forward said encrypted data to said digital radio broadcast domain based on a conditional access scheme.

In addition thereto, the above object is achieved by a method of transmitting data to a mobile device, said method comprising the steps of encrypting said data and forwarding said data to a digital radio broadcast domain based on a conditional access scheme.

Moreover, the above object is achieved by a method of receiving data at a mobile device, said method comprising the step of providing a conditional access to a digital radio broadcast data channel to enable receipt of said data via said digital radio broadcast data channel.

Finally, the above object is achieved by computer program products comprising code means configured to produce the above method steps when loaded into a memory of a server device, gateway device or mobile device, respectively.

Accordingly, data messages or data services can be received by a mobile device even outside the coverage of a mobile network, while still being protected by ciphering and conditional access methods. Especially, data receipt for initial message coverage for developing countries or rural message coverage for huge area countries can be enabled or extended. Thereby, a global messaging service can be implemented at substantially no hardware modifications, as the suggested solution can be implemented mainly or purely by modifications of functional features. Of course, the enhanced or modified functional features may as well be implemented by hardware or structural modifications.

The present solution provides increased functionality and business opportunities for consumers, vendors, operators, radio broadcasters and constitutes an important built-in feature for e.g. travelers, doctors, sailors and other people requiring data or message services in rural or developing areas. As an important advantage, no additional devices are required besides mobile devices and no retuning of radio stations is required due to automatic service follow-up. Moreover, while using the mobile device to listen to a digital radio station, data streams associated to extra services like text, multimedia, web pages or the like can be received.

If the mobile device is no longer within the coverage area of a mobile network, the proposed message forwarding mechanism via the digital radio broadcast data channel can be enabled and data can be transferred so that the mobile device can continue receiving messages via a digital radio interface. The initially described barrier between a radio broadcast domain and the mobile network domain can thus be removed by the present invention.

The radio broadcast access means may comprise a ciphering and/or access function for realizing the conditional access. In particular, the ciphering and/or access function may be based on security parameters, which may comprise, e.g., at least one of a ciphering key and a user or subscriber identity. Thereby, a point-to-point alignment and conditional access can be realized by using known subscriber identity-based ciphering and/or access methods.

Furthermore, the radio broadcast access means of the cellular receiver device may be configured to receive message objects belonging to a predetermined application identification which indicates the data. As a specific example, the radio broadcast access means may be configured to extract an unencrypted mobile subscriber identity from a received message object and to compare it with its own mobile subscriber identity. Then, the received message object can be extracted and decrypted in response to the comparison result. Particularly, the decryption may be based on the latest valid security parameters allocated to the mobile subscriber identity. This conditional access method guarantees that only the belonging addressee is able to receive his private message.

Furthermore, the radio broadcast access means of the cellular receiver device can be configured to discard the received message object if the message object has already been received by the cellular receiving means. This provides the advantage that messages which have already been received via the other receiving channel of the mobile network due to mobile network coverage are not displayed for a second time on the display of the mobile device. As specific examples, the message object may be a Short Message Service (SMS) message or a Multimedia Message Service (MMS) message.

The digital radio broadcast channel may be a channel of a Digital Radio Mondiale (DRM) system or a Digital Audio Broadcast (DAB) system.

As an additional feature, the cellular receiver device may comprise client means for setting up a connection to a server means so as to fetch new ones of said security parameters. Specifically, the client means may be configured to perform the setup each time a predetermined lifetime has elapsed. The client means may comprise a SyncML client. The fetched security parameters may be stored in a register means. During connection setup, the client means may use initial security parameters for authentication. If the connection setup has failed, the client means may retry connection attempts at regular time intervals. After a maximum lifetime without successful connection attempts has passed, the client means may delete the stored security parameters. These security features provide the advantage that user data security is significantly improved through frequent and secure changes of a publicly visible identity of the mobile device and the encryption keys. The proposed measures are well suited to integration of digital radio broadcast data services within mobile devices.

As another aspect of the present invention, the radio broadcast access means of the cellular receiver device may comprise service client means for enabling access to at least one of IP services and email services via the radio broadcast data channel. To achieve this, the server device may be configured to assign the mobile subscriber identity to a mobile device in response to a registration request. Additionally, the server device may assign a public user address, such as an IP address or an email address, in response to the registration request. In addition, storing means may be provided at the server device for storing a table linking the assign public user address to the assign mobile subscriber identity.

The above measures allow extension of the scope of the proposed solution to IP based services and email services which do not require any return channel.

In the server device, queuing means may be provided for queuing the data stream with the received data in chronological order.

Furthermore, the gateway means may be configured to encrypt the received data using security parameters.

As an additional measure, deleting means may be provided for deleting the received data from the queued data stream in response to the receipt of a recall request. By this recall operation the amount of messages to be broadcasted can be reduced in order to minimize the load on the broadcast channel.

The received data may comprise an email content, wherein the adding means may be configured to encapsulate the received email content into a radio broadcast packet, and wherein the message identity may be added to a header of the radio broadcast packet. As an alternative, the received data may comprise an IP packet, wherein the adding means may be configured to encapsulate the received IP packet into a radio broadcast packet, and wherein the message identity may be added to a header of the radio broadcast packet. In both above alternative cases, the message identity may be a temporary mobile subscriber identity.

The gateway means of the server device may be configured to reject the received data if a predetermined maximum data size has been exceeded.

Additionally, firewall means may be provided for filtering the received data so as to adhere to predetermined subscription parameters.

Exchange of the security parameters with the mobile device may be enabled by providing security server means at the server device. As already mentioned, the parameter exchange may be based on the SyncML open standard. The security parameters may comprise at least one of the mobile subscriber identity and the ciphering key. The security parameters may be stored in a security database of the server device. The stored security parameters may comprise initial security parameters and temporary security parameters. In this case, authentication for connection setup to the security server means may be based on the initial security parameters. This allows for resynchronization between the security database and the security register at the mobile device in case the temporary security parameters are no longer valid or no longer available.

Furthermore, the security server means may be configured to generate and store new temporary security parameters in response to a successful connection setup by the mobile device. If a maximum lifetime without successful connection setup has passed, the stored security parameters may be deleted.

The conditional access scheme based on which the gateway device forwards the encrypted data to the digital radio broadcast domain may define a predetermined offline time during which the mobile device has not been in the coverage area of the cellular network, wherein the data forwarding is started after expiry of the offline time. This prevents a toggling of the system between online and offline states which would create undesired or redundant traffic load on the digital radio broadcast data channel.

Furthermore, the gateway device may be configured to trigger a recall request if it is detected that the mobile device is again in the coverage area of the cellular network. Thereby, belonging user data left in the broadcast queue of the gateway device can be deleted to prevent redundant transmissions.

Based on subscriber database queries, the gateway device may detect whether the mobile device is within the coverage area, or not.

Further advantageous modifications are defined in the dependent claims.

### BRIEF DESCRIPTION OF THE DRAWINGS

In the following, the present invention will be described in more detail based on preferred embodiments with reference to the accompanying drawings, in which:

FIG. 1 shows a schematic diagram of a conventional network environment with coexistence of a conventional FM radio broadcast domain and a mobile network;

FIG. 2 shows a functional view of the conventional network environment of FIG. 1;

FIG. 3 shows a network environment with a global messaging service utilizing digital radio broadcast data channels, according to a first preferred embodiment;

FIG. 4 shows a functional view of the diagram of FIG. 3;

FIG. 5 shows a schematic block diagram of a multiplex configuration of a digital radio broadcast data channel;

FIG. 6 shows a diagram indicating channel options of a digital radio broadcast system;

FIG. 7 shows a message forwarding scheme according to the first preferred embodiment;

FIG. 8 shows a diagram indicating message types and required infrastructure according to the first preferred embodiment;

FIG. 9 shows a schematic diagram of a conditional access scheme for digital radio broadcast message objects according to the first preferred embodiment;

FIG. 10 shows a schematic diagram of an IP-over-DRM system configuration according to a second preferred embodiment;

FIG. 11 shows a schematic diagram of an Email-over-DRM system configuration according to a third preferred embodiment; and

FIG. 12 shows a modified system configuration for secure data transport with independent security parameters according to a fourth preferred embodiment.

### DESCRIPTION OF THE PREFERRED EMBODIMENTS

The preferred embodiments will now be described on the basis of a network environment comprising a 2G or 3G mobile communication network and a DRM system domain.

DRM is a non-proprietary, digital radio broadcast system with the ability to use existing frequencies and bandwidth below 30 MHz across the globe. The European Telecommunications Standards Institute (ETSI) has published a technical specification of the DRM system, called ETSI ES 201 980 V1.2.1, “Digital Radio Mondiale (DRM)—System Specification”. DRM allows transmission of different classes of information, such as audio, data, etc. and does not differentiate between different services that may be conveyed within one or more classes of information. Further details concerning the DRM system can be gathered from the web page www.drm.org.

Additionally, an alternative second digital radio broadcast system, the Digital Audio Broadcast (DAB) system, has been developed to allow broadcast of digital information over terrestrial networks. DAB can carry not only audio, but also text, picture, data and even video information. Further details concerning the DAB system can be gathered from the web page “www.worlddab.org”.

According to the preferred embodiments, a global messaging service is enabled towards mobile devices via digital radio data channels of digital radio broadcast systems, such as DRM or DAB or any other available digital radio broadcast system, to provide message reception even outside the coverage area of a mobile network. Due to the general accessibility of these systems, encryption/decryption is used for realizing conditional access on the radio broadcast interface. Thereby, initial message coverage for developing countries or extended rural message coverage for large-area countries can be provided at minor hardware changes. Thereby, services such as emergency and traveler messaging, paging replacement and receiving subscription channels, such as news and weather, can be forwarded irrespective of mobile coverage.

The present invention has influence on three areas of communication systems, namely mobile devices with integrated radio receivers, mobile operator networks, and radio broadcast systems. In particular, the mobile operator domain with the related 2G and/or 3G services is combined with the digital radio broadcast domain in order to receive mobile messages outside a mobile network by using data channels of the digital radio broadcast systems. By equipping next generation mobile devices with digital radio receivers according to the DRM or DAB standard, those receivers will on the one hand replace the existing analogue FM radio receivers and on the other hand enable additional data services by using data channels of these digital broadcast systems as well as the already available subscriber identity-based encryption methods of mobile devices to transport messages outside the mobile network.

The following description of the preferred embodiments is based on the DRM system of a digital data broadcast domain. DRM operates below 30 MHz and, depending on the transmission frequency and the related propagation characteristics, even continental-wide or world-wide distribution can be considered with just one carrier frequency. In particular, the proposed system can be used for both 2G or 3G cellular networks and is especially interesting for developing countries and huge area countries to provide extended coverage for message transfer. In addition, the present invention allows an anytime/anywhere reachability opportunity for groups like travelers, doctors, installation technicians, sailors and the like. Any kind of world-wide paging applications may even be replaced without the need of having certain paging devices, but by just using the embedded DRM receiver in the mobile device.

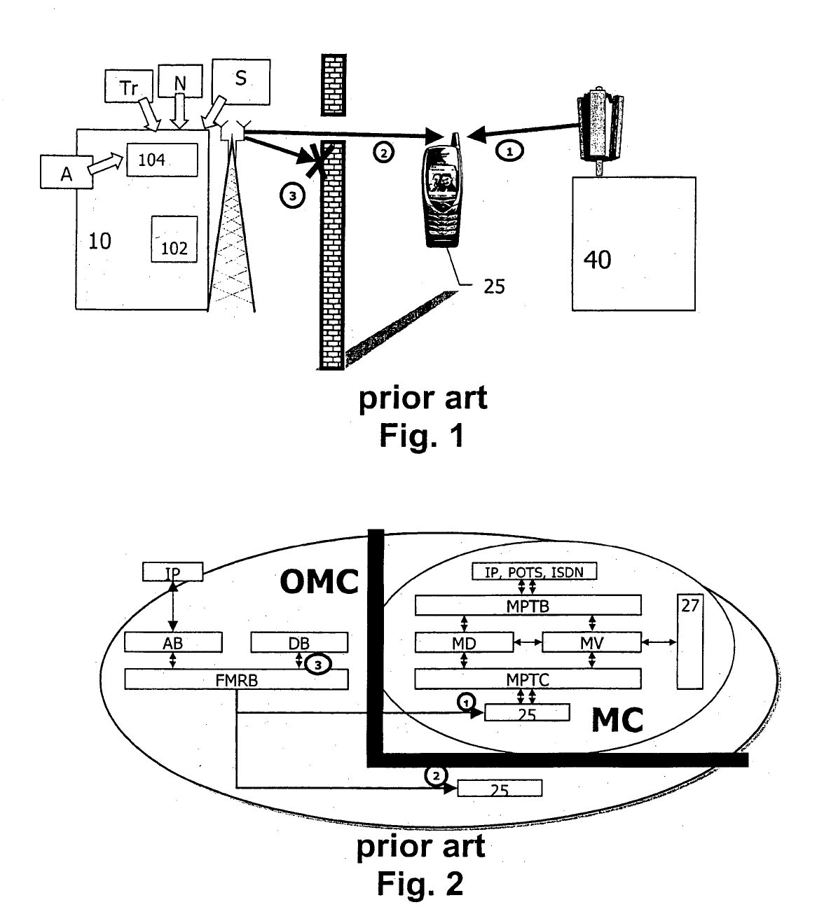

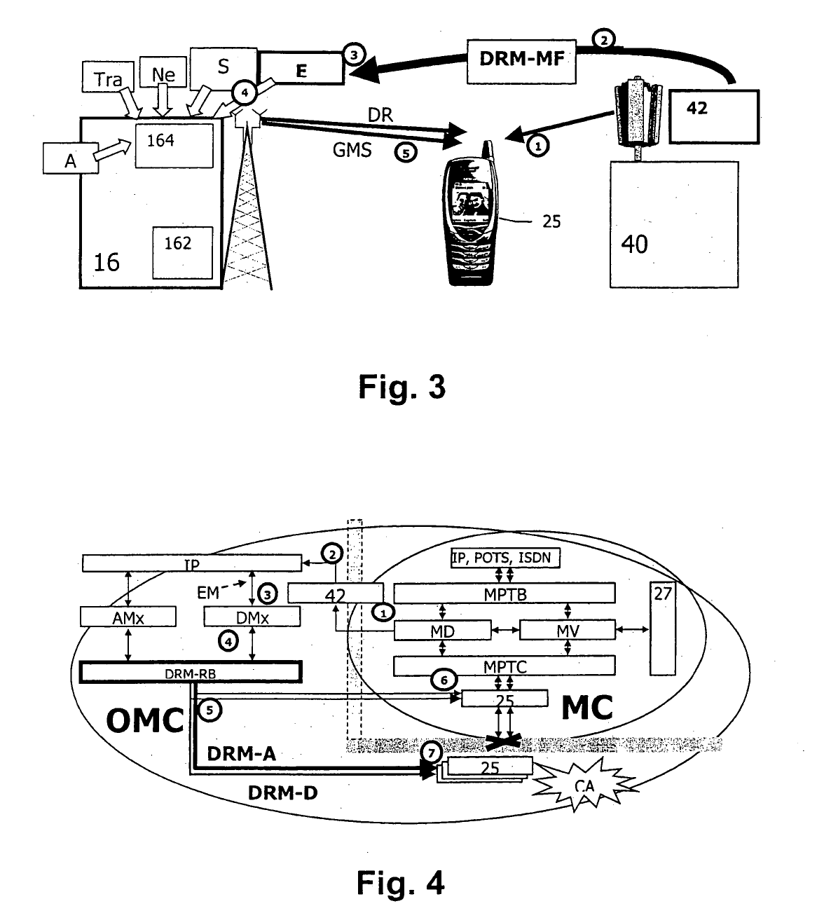

FIG. 3 shows a network environment with a global messaging service utilizing digital radio broadcast data channels, according to a first preferred embodiment. A DRM radio broadcast domain 16 is fully linked with the mobile network 40, which means that related mobile services are available outside the coverage area of the mobile network 40. As long as the mobile device 25 is “online”, i.e. is located within the coverage area of the mobile network 40, and there is no difference to the system of FIG. 1, since the mobile device 25 can receive services of the mobile network from the mobile network itself, as indicated by the arrow \mathring{1}. It is further possible to listen to digital radio (DR) received from digital radio stations via DRM radio broadcast as indicated by the upper arrow \mathring{5}.

If the mobile device 25 is no longer within the coverage area of the mobile network 40, a message forwarding mechanism DRM-MF is enabled via a DRM gateway 42, as indicated by the arrow \mathring{2} and encrypted messages \mathring{3} can be transferred to a DRM radio content server 164 which may be provided in the DRM broadcast domain 16, so that the mobile device 25 can continue receiving messages by the global messaging services (GMS) via the digital radio interface, as indicated by the lower arrow \mathring{5}. In particular, the DRM content server 164 can now receive, besides audio streams A, traffic information Tra, news information Ne, and station/song information S, encrypted messages E to be forwarded to a DRM radio transmitter 162 for terrestrial broadcast transmission. The supply of the encrypted messages received from the mobile network domain is indicated by the arrow \mathring{4}. Point-to-point alignment and conditional access can be realized by using SIM (Subscriber Identity Module) or IMSI (International Mobile Subscriber Identity) based ciphering and/or access methods, as explained later.

FIG. 4 shows a similar situation as FIG. 3 but from a functional point of view, wherein the mobile device 25 is fully connected to messaging services in areas OMC without mobile coverage as indicated by the arrow \mathring{7}. Within the mobile coverage area MC, the mobile device 25 may only receive mobile services via the mobile physical transport services MPTC of the consumer such that a barrier is provided to the outside mobile coverage region OMC. However, inside the mobile coverage region MC, digital radio services can be received as indicated by the arrow \mathring{6}. If the mobile device 25 is in the outside mobile coverage region OMC, mobile services such as mobile data MD are forwarded as messages to the DRM gateway 42 (arrow \mathring{1}) and then to an IP network such as the Internet (arrow \mathring{2}). The messages are forwarded as encrypted messages (EM) (arrow \mathring{3}) to a data multiplex (DMx) function of the DRM domain 16. The multiplexed data stream is supplied together with a multiplexed audio stream generated in an audio multiplex (AMx) function to the DRM radio broadcast service DRM-RB (arrow \mathring{4}) and is then forwarded as a digital radio broadcast data transmission comprising audio and data broadcast information to the mobile device 25 (arrow \mathring{5}). However, due to the subscriber identity based ciphering and access methods, only conditional access (CA) to mobile services is possible by the mobile device 25 outside the coverage area of the mobile network 40. Hence, global messaging services can be received outside the mobile network 40 by using conditional access methods. The dotted grey bar in FIG. 4 indicates that the barrier regarding message reception between broadcast domain and the mobile network domain has been removed by the present invention.

Considering the differences in network coverage between a DRM broadcast beam covering seamless huge parts of countries like the United States, and the coverage of a wireless mobile network with related small coverage spots, the advantage of the present invention becomes apparent.

An implementation of the present invention requires mobile devices with digital radio broadcast receiving functionality, updates for messaging gateways in the mobile operator domain for enabling the message forwarding mechanism, and a secure transport link between the radio broadcast domain and the mobile network domain in order to receive encrypted messages to be broadcasted.

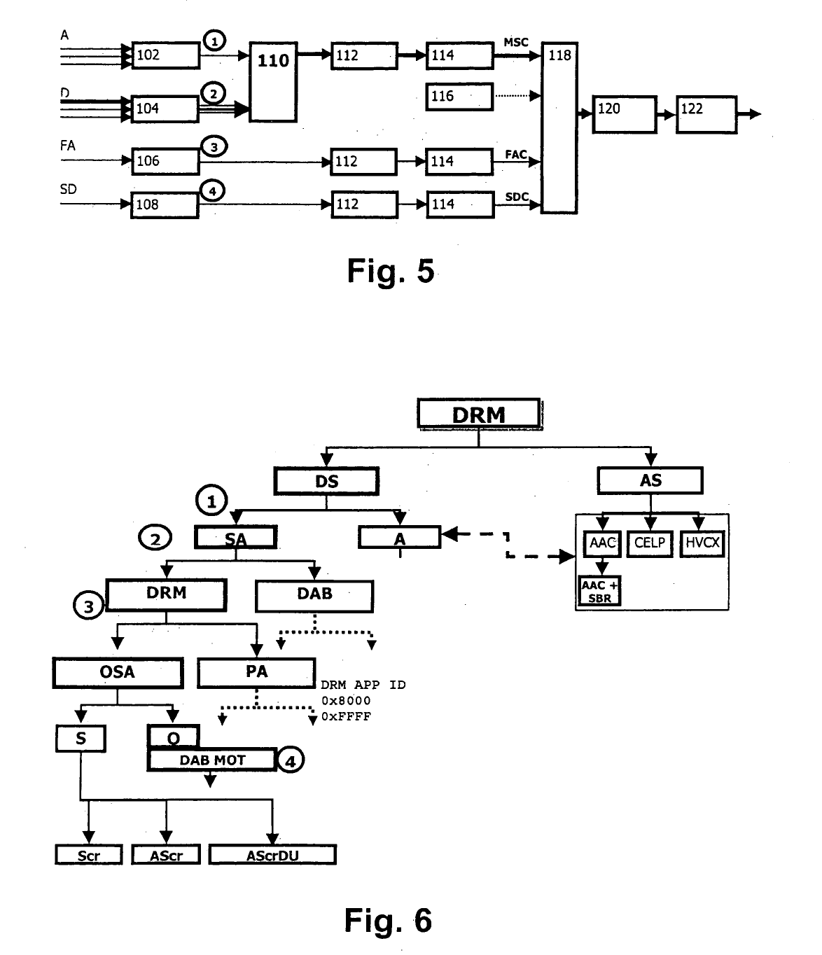

FIG. 5 shows a schematic block diagram of a DRM multiplex configuration based on the ETSI specification ES 201 980 V1.2.1 DRM broadcast is a digital broadcast with a digital frame structure which is called the DRM multiplex. Four audio/data streams can be multiplexed together at maximum within that structure. Thus, either one to four data streams separately, one to four audio streams separately, or a mixture of those two types of streams can be transported. Audio streams A are supported with several codecs 102, matching the required needs, from mono speech up to high quality stereo signals. Data streams D can be put to the DRM multiplex via respective codecs 104 by either synchronous or asynchronous data streams, or by adding separate object files to the stream, like encrypted messages, as indicated by the multi-line arrow \mathring{2} in FIG. 5. The data streams D and audio streams A \mathring{1} are combined by a multiplex functionality 110 followed by a channel encoder 112 and a cell interleaver 114 to the main service channel MSC. In addition, fast access information FA is supplied to a precoder 106 of a fast access channel FAC \mathring{3} followed by a channel encoder 112 and a cell interleaver 114. This fast access information FA comprises important information to enable fast access to the DRM multiplex and to retrieve certain data streams with the allocated application identification (ID) which can be used for the present mobile message forwarding. Finally, service description information SD multiplexed via a service description channel SDC \mathring{4} comprising a precoder 108, a channel encoder 112 and a cell interleaver 114. The service description information SDC comprises detailed information about all services within the DRM multiplex. The main service channel MSC, the fast access channel FAC and the service description channel SDC are supplied together with a pilot signal generated by a pilot generator 116 to an OFDM (Orthogonal Frequency Division Multiplex) cell mapper 118 which combines the signals and supplies them to an OFDM signal generator 120 which generates an OFDM signal and supplies it to a modulator 122. The modulated data stream is then forwarded to the broadcast transmitter 162. Further details concerning the individual functions of the elements shown in FIG. 5 can be gathered from the ETSI specification ES 201 980 V1.2.1.

FIG. 6 shows a diagram indicating channel options for DRM data services e.g. within a mobile switching center (MSC) of the mobile network 40. On the right-hand side all the encoder options for audio services (AS) are listed, while options for data services (DS) can be seen on the left-hand side of FIG. 6. Data services (A) which are associated with some audio streams shall not be used for mobile message broadcast due to the fact that those streams belong to a certain radio station and contain station-related information like artists, album, news, traffic, etc. The abbreviations AAC, CELP, HVCX, and SBR designate specific encoder options which are described in detail in the above DRM specification.

The remaining stand-alone applications (SA) \mathring{1} can be distinguished between DRM and DAB domain applications. Background here is that a certain application must be developed only once to be then configured to both DRM and DAB channels without additional effort. Due to the DRM specific propagation characteristics, the DRM domain may be more feasible for specific applications \mathring{2}. Nevertheless, it is to be pointed out that the present invention is fully compatible to DAB radio broadcast.

Within the DRM domain, openly specified applications (OSA) \mathring{3} and proprietary applications (PA) are known. As it is desired to enable the forwarding mechanism in a standardized way for both DRM broadcast operators and mobile network operators, an openly specified message forwarding application may be desirable. Proprietary applications may be assigned DRM application IDs, such as an address range “0x8000” to “0xFFFF” as indicated in FIG. 6.

The openly specified applications (OSA) may relate to streams (S) or objects (O). The streams may comprise synchronous data (Scr), asynchronous data (AScr), or Asynchronous data units (AScrDU). A simple way to put the present GMS data to the DRM multiplex is just to add files as objects, if they appear at the DRM content server 164, e.g. by using the DAB Multimedia Object Transfer (MOT) protocol \mathring{4}, as specified in the ETSI specification EN 301 234. The MOT protocol is used for transferring file oriented data in DAB data channels.

The range of provided data rates varies from 4.8 kbit/s to 72 kbit/s, meaning maximum gross transfer volume of about 759 Mbyte each day, more realistic figures regarding message broadcast are about 100-200 Mbyte a day, depending on chosen robustness and protection mode, which is about 1 million text messages a day for each broadcast beam. Thus, according to the preferred embodiments, DRM message forwarding may be based on a conversion of the data into objects based on the DAB MOT protocol (ETSI EN 301 234) and forwarding these object files to the DRM content server 164. Other optional DAB-like transport mechanism are Transparent Data Channel (ETSI TS 101 759) or IP datagram tunneling (ETSI ES 201 735). Related application shall be registered in the DRM data applications directory ETSI TS 101 968 V1.1.1.

In order to realize global messaging services, the message forwarding mechanism has to cope with the restricted data bandwidth of the DRM data channels. Therefore, a message should only be forwarded if really required, meaning that no mobile network coverage is available. In addition, preferable forwarding objects should be small-sized objects like SMS

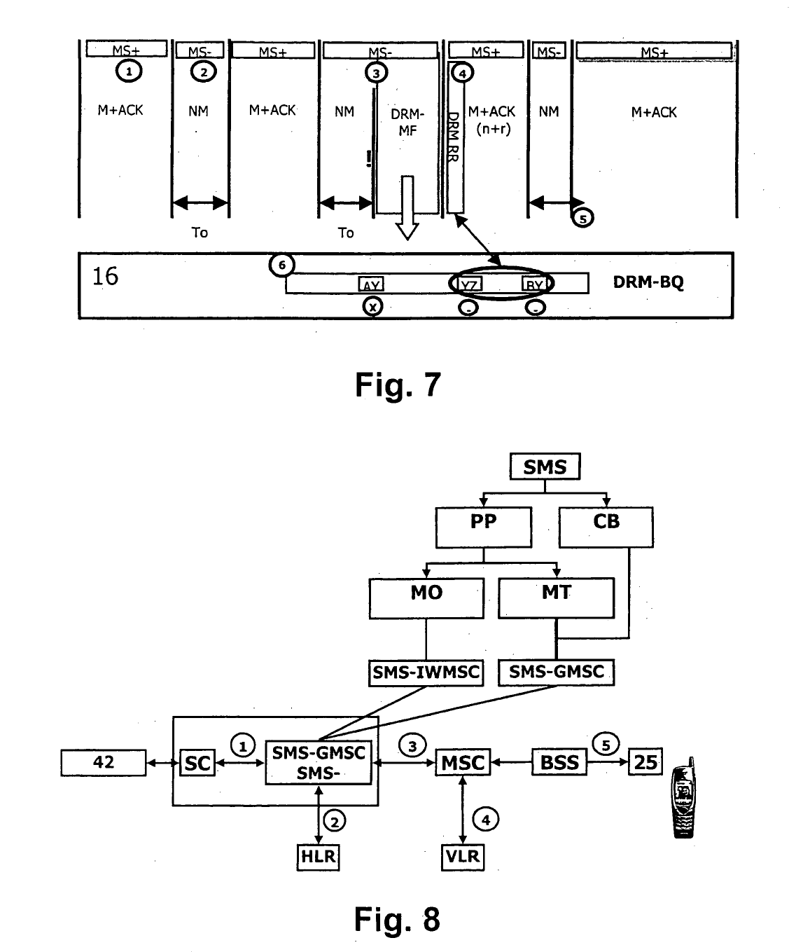

FIG. 7 shows an example of a message forwarding mechanism according to the first preferred embodiment. According to FIG. 7, the coverage state of the mobile station (MS) or mobile device 25 is shown as bars in the upper portion, wherein “MS+” indicates that the mobile device 25 is located within the mobile coverage area MC and “MS−” indicates that the mobile device 25 is in the outside mobile coverage area OMC. The block on the lower part of FIG. 7 indicates DRM domain 16 with a DRM broadcast queue \mathring{6} which comprises object files to be broadcast by the DRM radio transmitter 162. As long as the mobile device 25 is located within the coverage area of the mobile network 40, messages are transferred over the related channel of the mobile network 40 with corresponding acknowledgments. Message forwarding towards the DRM broadcast domain 16 is disabled \mathring{1}.

If the mobile device 25 is offline for a very short time period, shorter than a threshold time period To, also no message forwarding to the DRM broadcast domain 16 is activated as indicated by \mathring{2} and \mathring{5}. The related system value which may be called “allowed offline time” To is programmable and prevents the system from toggling fast between online and offline states, which otherwise could generate unwanted and unnecessary DRM broadcast traffic. A reasonable value for the allowed offline time threshold To could be e.g. one hour.

If the offline time of the mobile device 25 exceeds this programmed threshold value To, the message forwarding mechanism DRM-MF starts towards the DRM content server 164 of the DRM broadcast domain 16 \mathring{3}. All messages are put to the DRM broadcast message queue in chronological order, together with a unique user ID, which can be based on the IMSI. The DRM broadcast transmitter 162 now processes the queue and sends one message after the other over the air. If the complete queue is processed, broadcasting can start from the beginning of the queue again. Thereby, the probability of proper reception of the messages can be increased, as due to the nature of the broadcast transmission no acknowledgment is available.

When the mobile device 25 is online again, e.g. is again located within the coverage MC of the mobile network 40, the mobile network 40 triggers a DRM recall request DRM-RR \mathring{4} which initiates recall and deletion of all messages from the DRM broadcast queue, which belong to a specific mobile subscriber and the related unique User ID. The belonging messages can be addressed by the above mentioned unique User ID. The recall operation is desirable for the following reason. If the mobile device 25 is online again, DRM broadcast is not needed any longer, and the mobile device 25 may receive all the messages again via the traditional or conventional mobile network message channel, for example also those messages which have already been sent during offline time via the DRM broadcast, just to be sure that no single message is missed. The recall operation serves to reduce the amount of messages to be broadcast all the time in order to keep the broadcast channel “clean” and prevent redundant double transmission. If a message has already been received successfully via the DRM broadcast channel, the second reception of the message is discarded at the mobile device 25 and not shown again on the graphic user interface (GUI), e.g. display, of the mobile device 25, and vice versa.

As can be seen from FIG. 7, the encircled object files with message IDs “YZ” and “BY”, belonging to a unique User ID, are covered by the DRM recall request. As a consequence, an allocated “send” token “X” is deleted or reset, such that they will not be sent via the broadcast channel.

FIG. 8 shows diagram indicating message types and the required infrastructure according to the first preferred embodiment. A great advantage of the present invention is that the related network functions require no additional hardware and only need to be updated with respect to their processing functionalities, which can be achieved by software updates. The related network functions are the SMS Service Center (SC), the SMS-Interworking MSC (SMS-IWMSC), the SMS-Gateway MSC (SMS-GMSC) \mathring{1}. The SMS may be forwarded via a point-to-point (PP) connection or via cell broadcast (CB). If the message receiving mobile device 25 of a mobile terminated (MT) PP message is offline, the message sending mobile device of the mobile originated (MO) message transfers the message via the SMS-IWMSC and SC towards the DRM gateway 42. If the message receiving mobile device 25 is online again, the stored messages in the SC are sent again towards the receiving mobile device 25, and furthermore the SC initiates a DRM message recall towards the DRM gateway 42. In CB or MT cases, the message is transferred via the SMS-GMSC. Both SMS-IWMSC/SMS-GMSC and SC may need corresponding updates in functionality. Information concerning enabling of the DRM message forwarding feature can be derived from either a subscriber database such as the Home Location Register (HLR) and the Home Subscriber Server (HSS) \mathring{2}, or from a separate database on the DRM Gateway 42. Additionally, offline/online time stamping indicating mobile coverage faced by the concerned mobile device 25 can be derived from the HLR or HSS, or via an MSC from the allocated Visitor Location Register (VLR) \mathring{2}, \mathring{3}, \mathring{4}. Consequently, the access to the mobile device 25 via the Base Station Subsystem (BSS) is remained untouched and requires no modification \mathring{5}.

At the mobile device 25 a functionality or software routine representing messages on the GUI of the mobile device 25 can be updated in such a manner that double indication of the same message received via both the mobile air interface and the DRM broadcast shall be prevented. As the messages forwarded using the DRM forwarding mechanism are broadcasted via the DRM radio transmitter 162 to anybody and anywhere, a method must be provided which guarantees that only the belonging addressee is able to receive his private message. This can be assured by using a unique subscriber identity (e.g. SIM/IMSI) based conditional access method.

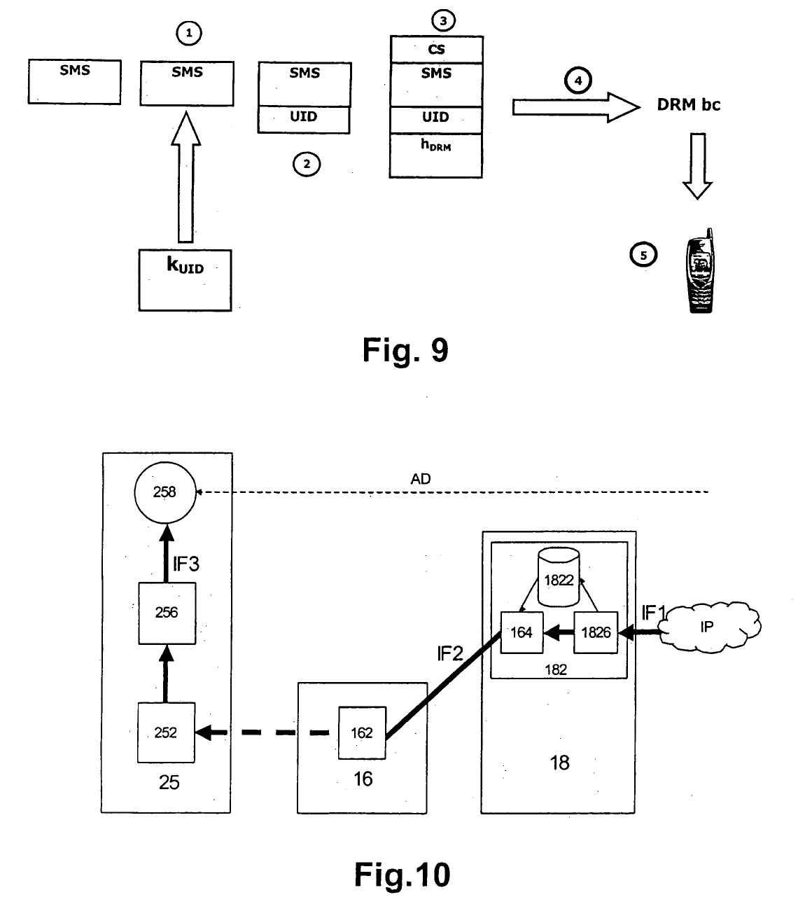

FIG. 9 shows a simple example of such a conditional access method for DRM broadcast message objects according to the first preferred embodiment. Each time the mobile device 25 is located within the coverage area of the mobile network 40 and thus comes “alive” within the mobile network 40, a new encryption key k_{UID} is calculated, e.g. by some known 2G/3G algorithm, and is stored both inside the (U)SIM module of the mobile device 25 as well as in the mobile network 40. Optionally, this encryption key k_{UID} may also used for encryption of the messages forwarded by the DRM message forwarding mechanism \mathring{1}.

For enabling access to the encrypted message, the unencrypted unique User ID can be added to the message \mathring{2}. Finally, the DRM content server 164 puts this message object to the upload and broadcast file space, where each message is broadcast, e.g. as a DRM data stream object file \mathring{3}. This object file comprises an additional checksum cs and DRM header h_{DRM} according to the DRM specifications. Broadcast of these messages \mathring{4} for a certain mobile device 25 identified by its unique User ID is repeated as long as no message recall event occurs, i.e. as long as the mobile device 25 is not online again and messages have to be removed, and as long as a programmable broadcast time limit has not exceeded. That is, messages are forwarded only for a limited period of time beyond which they expire even if no recall operation has occurred. Thereby, transmission load on the broadcast channels can be reduced.

In the DRM receiver of the mobile device 25, the reception process is exactly vice versa, which means that all DRM message objects belonging to the related DRM application ID are received and DRM headers are removed. The received unencrypted unique User ID is extracted and compared to the User ID stored at the mobile device 25. If the received ID matches with the own ID, the encrypted message is extracted and the original message is decrypted by using the latest valid ciphering key stored in the SIM module of the mobile device 25. If the message has already been received meanwhile via traditional mobile network paths, the message is discarded and not displayed again on the GUI of the mobile device 25.

In the following, additional second and third embodiments are described in which a DRM service provider functionality is provided independently from the mobile networking service. The DRM broadcast station operator may act as a DRM service provider himself or he may cooperate with another one.

FIG. 10 shows a schematic block diagram of an IP data transport mechanism over the DRM broadcast channel according to the second preferred embodiment. Unicast IP packets are forwarded over a DRM bearer using a DRM-IP gateway 182 provided in a DRM-IP service provider 18 arranged in a server device. According to the well known OSI (Open System Interconnection) reference model, the DRM radio channel can be regarded as a Data Link Layer (Layer 2) which is suitable to carry IP packets. This allows for any kind of IP-based services which do not require any return channel. A particular example are push-type services where information is pushed from IP networks to terminal devices without requiring any request or initiation in the uplink direction. The service can be provided by the DRM-IP service provider 18 which may be independent from the mobile network 40.

The mobile device 25 can be addressed by a unique mobile station or mobile subscriber identity, e.g. a Mobile Station International ISDN number (MSISDN) or the IMSI or Temporary Mobile Subscriber Identity (TMSI).

When a user subscribes to the DRM-IP service, it registers at the DRM-IP service provider 18 and will be assigned a mobile subscriber or station ID (MSID), a temporary mobile subscriber or station ID (TMSID), a key and a temporary key, as described in the above first preferred embodiment. Then, the user will be assigned a public IP address by the DRM-IP service provider 18. This public IP address may be assigned permanently, i.e. for the duration of the service contract. Then, the DRM-IP service provider 18 links the given IP address to the temporary mobile subscriber ID of the user by means of a TMSID look-up table (LUT) 1822 provided in the DRM-IP gateway 182.

Any IP packet sent to such an assigned IP address will be sent from the IP network via routers and a first interface IF1 to the DRM-IP gateway 182 and will be processed there. In particular, the IP destination address will be mapped to the corresponding TMSID using the TMSID LUT 1822 for addressing the mobile device 25. If a valid TMSID is stored in the TMSID LUT 1822, the packet will be further processed.

If the size of the packet exceeds the Maximum Transfer Unit (MTU) size of the DRM packet, which is the largest size of an IP datagram which may be transferred using a specific data link connection, and the “Don't Fragment” bit is set, an IP router functionality 1826 of the DRM-IP gateway 182 returns an ICMP “Destination Unreachable” message to indicate that the packet cannot be processed. The MTU value is a design parameter and a mutually agreed value (i.e. both ends of a link agree to use the same specific value). The size of MTU may vary greatly between different links (from 128 byte up to 10 kbyte). As specified in the Internet Engineering Task Force (IETF) specification RFC 1191, the MTU for the next network hop, i.e. the DRM channel, must be encoded in this ICMP (Internet Control Message Protocol) packet. This process is known as “MTU Path Discovery”.

On the other hand, if the size of the packet does not exceed the MTU size, the IP router functionality 1826 forwards the IP packet, e.g. with fragmentation, if required. Optionally, the IP packet may be filtered by a firewall function provided at the IP router function 1826 to adhere to certain subscription parameters, such as maximum amount of data per day, IP source address filters, etc. The firewall functionality may be configured to let pass only UDP (User Datagram Protocol) frames which don't require any acknowledgements from the mobile device 25, to thereby ensure unidirectional traffic.

Then, the IP packet will be encapsulated into a DRM packet by a DRM content server 164 of the DRM-IP gateway 182. The functionality of the DRM content server basically corresponds to that of the first preferred embodiment described above. The DRM packet header contains the TMSID. Finally, the DRM packet is sent out to the DRM radio transmitter 162 via a second interface IF2 at the DRM broadcast station or broadcast domain 16.

At the mobile device 25, a DRM receiver functionality 252 is provided which extracts the IP packet and forwards it to a DRM IP client functionality 156 which processes the IP packet and forwards it via a third interface IF3 to a corresponding IP application 258 which corresponds to the received IP service. Thus, as indicated by the dotted arrow, application data relating to an IP service can be forwarded to the mobile device 25 via the proposed DRM forwarding mechanism without requiring any mobile network coverage.

In FIG. 10, the first interface IF1 designates an interface between the IP network, e.g. the Internet, and the DRM-IP gateway 182, based on IP standards. The second interface IF2 designates an interface between the DRM-IP gateway 182 and the DRM broadcast domain 16, based on DRM standards. Finally, the third interface IF3 designates a standard IP socket interface between a user agent and a higher IP protocol layer.

Thus, the second preferred embodiment extends the scope of the first preferred embodiment to IP based services which do not require a return channel.

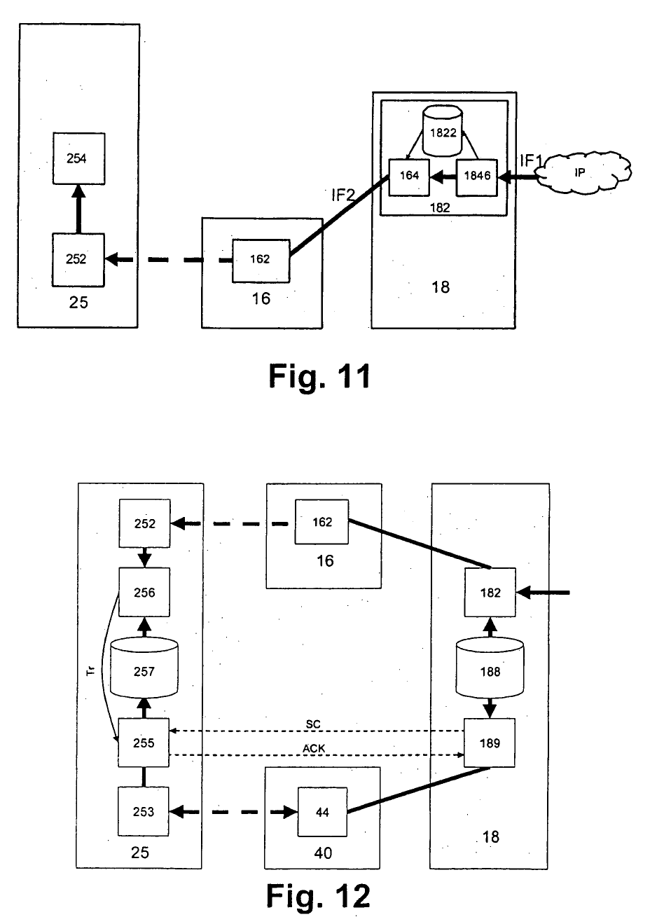

FIG. 11 shows a schematic block diagram of a third preferred embodiment which enables email transport over the DRM broadcast channel. According to the third preferred embodiment, email messages can be forwarded over a DRM bearer, wherein a DRM Email gateway 182 is provided in a DRM service provider 18 and configured to provide an email service. The DRM service provider 18 thus functions as a DRM-Email service provider which may be independent from the mobile network 40.

When a user subscribes to the DRM email service, it registers at the DRM Email service provider 18 and will be assigned a mobile subscriber or station ID (MSID), a temporary mobile subscriber or station ID (TMSID), a key and a temporary key as described in the other preferred embodiments. Furthermore, the user will be assigned a public email address by the DRM email service provider 18, e.g. “<username>@<provider_domain>”.

Similar to the second preferred embodiment, the DRM Email service provider 18 provides a link between the given email address and the TMSID of the user by means of TMSID LUT 1822.

Any email sent to the assigned public email address will be processed by the DRM Email gateway 182, in particular by an Email server functionality 1846. The email content may be filtered to adhere to certain subscription parameters, such as message size, format, number of messages per day, source address filters, etc. Then the email destination address will be mapped to the corresponding TMSID using the TMSID LUT 1822 for addressing the mobile device 25. If a valid TMSID has been looked up, the email message will be further processed by the DRM content server 164 which is also provided in the DRM Email gateway 182. In particular, the email content will be encapsulated into a DRM packet and the DRM packet will be sent out to the DRM radio transmitter 162 of the DRM broadcast domain 16.

The mobile device 25 receives the DRM message via the DRM broadcast channel by its DRM receiver 252 which supplies the received email message to a DRM email client function 254. This email client function 254 may be configured to display the email message at a GUI of the mobile device 25.

Similar to the second preferred embodiment, the first interface IF1 between the IP network and the DRM email gateway 182 is based on Internet standards, while the second interface IF2 between the DRM Email gateway 182 and the DRM broadcast domain 16 is based on DRM standards.

Thus, the third preferred embodiment allows extension of the scope of the first preferred embodiment to an email service.

The mobile network operator is in possession of the mobile subscriber identity and the encryption keys, i.e. the security parameters, related to its own cellular service. Therefore, the independent DRM service provider 18 described in connection with the second and third preferred embodiments has no access to those security parameters. It is thus suggested to use additional security parameters independent from the mobile network operator which are generated by the DRM service provider, and to exchange these security parameters based on specific synchronization methods. The DRM service provider and the DRM client running on the mobile device both may maintain the security parameters in respective memories. The security parameters may have a certain minimum lifetime after which the mobile device tries to initiate a bidirectional synchronization communication while it can authenticate itself with the initial service parameters.

According to the fourth preferred embodiment, such a secure data transport over the DRM broadcast channel is provided for independent DRM service providers as described in the above second and third preferred embodiments. In particular the problem of changing both mobile station identity and message encryption key for an a-priori unidirectional data transport infrastructure is solved.

Security in cellular systems, such as Global System for Mobile communication (GSM) or Universal Mobile Telecommunications System (UMTS), includes frequent changes of the mobile station identity and data encryption keys. However, this procedure is based on the system's inherent bidirectional data transfer capability. Thus, changing keys and identity requires bidirectional data transfer capability, since the transmitter needs to know if the receiver has adjusted to a changed identity.

In the present fourth preferred embodiment, it is therefore proposed to use security parameters, such as mobile station identity or keys, which are generated by the DRM service provider 18 itself, and to exchange or renew these security parameters based on a synchronization mechanism, such as SyncML which is the leading open industry standard for universal synchronization of remote data and personal information across multiple networks, platforms and devices. The connection through which the security parameters are being exchanged must be secure, e.g. through a GSM/GPRS (Global Packet Radio Service), EDGE (Enhanced Data rates for GSM Evolution) or 3G call. Since the DRM receivers are expected to be integrated with the mobile device 25, this can be accomplished easily.

FIG. 12 shows a modified system configuration for secure data transport with independent security parameters according to the fourth preferred embodiment. The DRM service provider 18 maintains the security parameters for all users in a security database 188.

For each user, the initial security parameters, e.g. MSID and ciphering key, as well as the temporary security parameters, e.g. TMSID and temporary ciphering key, will be stored there. A DRM client 256 running on the mobile device 25 maintains the security parameters in a security parameter register 257. The security parameters have a certain minimum lifetime Tₘᵢₙ, which may be configurable. When Tₘᵢₙ has elapsed, a SyncML client 255 running on the mobile device 25 is triggered by the DRM client 256 and tries to set up, via the mobile network 40, a connection to a SyncML server 189 at the DRM service provider 18. Due to the security of the connection, the mobile device 25 can authenticate itself with the initial security parameters. This allows for resynchronization between the security database 188 and the security register 257 even in case the temporary security parameters have expired or have been lost.

If the connection setup is successful, the SyncML server 189 will fetch new temporary security parameters from the security parameter database 188 of the DRM service provider 18 and the security register 257 at the mobile device 25 will be updated securely. Hence, when this transaction has been completed, the new security parameters can be used for DRM message forwarding as described in the above embodiments.

On the other hand, if the connection setup is not successful, i.e. if the mobile device 25 is still out of cellular coverage, the mobile device 25 will retry connection attempts in predetermined intervals T_{retry}, which may be configurable. Once successful, the security parameters will be renewed securely as described above. Otherwise, the current security parameters will remain. This connection retry will continue until a maximum lifetime Tₘₐₓ, which may be configurable, has been reached. At this point, the security parameters at both the mobile device 25 and the DRM service provider 18 will expire and no data can be received anymore over the DRM forwarding mechanism including the DRM gateway 182, the DRM broadcast domain 16 with the DRM radio transmitter 162 and the DRM receiver 252 at the mobile device 25. Then, the mobile device 25 will continue trying to set up a connection to the DRM service provider 18 via a cellular data transmission/receiving functionality 253 provided at the mobile device (25) and a cellular data transmission/receiving functionality 44 of the mobile network 40 to reestablish the service again.

For the user or message data transfer over the DRM broadcast channel, the mobile device 25 will be addressed by the TMSID and all user data will be encrypted with the temporary key by a suitable encryption algorithm.

Thus, the suggested synchronization mechanism improves user data security significantly through frequent and secure changes of the temporary security parameters.

It is noted that the present invention is not limited to the above preferred embodiments, but can be implemented in any network environment where a digital radio broadcast domain can be combined with a cellular network domain. Any kind of conditional access based on any kind of security parameters for identification and/or encryption is considered to be covered by the present invention. The preferred embodiments may thus vary within the scope of the attached claims.

1. A cellular receiver device for receiving data from a data source, said cellular receiver device comprising:
cellular receiving means for enabling receipt of said data from a cellular network domain; and
radio broadcast access means for providing conditional access to a digital radio broadcast data channel to enable receipt of said data via said digital radio broadcast data channel.

2. A receiver device according to claim 1, wherein said radio broadcast access means comprises at least one of a ciphering function and an access function for realizing said conditional access.

3. A receiver device according to claim 2, wherein said at least one of aid ciphering and said access function is based on security parameters.

4. A receiver device according claim 1, wherein said radio broadcast access means are configured to receive message objects belonging to a predetermined application identification which indicates said data.

5. A receiver device according to claim 4, wherein said radio broadcast access means are configured to extract an unencrypted mobile subscriber identity from a received message object and to compare it with a mobile subscriber identity of said radio broadcast access means.

6. A receiver device according to claim 5, wherein said radio broadcast access means are configured to extract and decrypt said received message object in response to a comparison result.

7. A receiver device according to claim 6, wherein decryption of said received message is based on latest valid security parameters allocated to said mobile subscriber identity.

8. A receiver device according to claim 7, wherein said security parameters comprise at least one of a temporary ciphering key and a temporary identity.

9. A receiver device claim 4, wherein said radio broadcast access means are configured to discard said received message object if said message object has already been received by said cellular receiving means.

10. A receiver device according to claim 4, wherein said message object is one of a Short Message Service message and a Multimedia Message Service message.

11. A receiver device according to claim 1, wherein said digital radio broadcast channel comprising one of a channel of a Digital Radio Mondiale system and a Digital Audio Broadcast system.

12. A receiver device according to claim 3, further comprising client means for setting up a connection to a server means via said cellular network domain so as to obtain new security parameters.

13. A receiver device according to claim 12, wherein said client means is configured to perform a setup each time a predetermined lifetime has elapsed.

14. A receiver device according to claim 12, wherein said client means comprises a SyncML client.

15. A receiver device according to claim 12, further comprising register means for storing said obtained security parameters.

16. A receiver device according to claim 12, wherein said client means are configured to use initial security parameters for authentication during a connection setup.

17. A receiver device according to claim 12, wherein said client means are configured to retry connection attempts at regular time intervals, if a previous connection setup has failed.

18. A receiver device according to claim 12, wherein said client means are configured to delete said stored security parameters after a predetermined lifetime without successful connection attempts has passed.

19. A receiver device according to claim 1, wherein said radio broadcast access means comprise service client means for enabling access to at least one of IP services and email services via said radio broadcast data channel.

20. A server device for providing a data service to a mobile device, said server device comprising:
gateway means for receiving data from an external data source and for mapping a destination address of received data to a mobile subscriber identity; and
adding means for adding said mobile subscriber identity to said received data, and for putting said received data with said mobile subscriber identity to a data stream to be broadcast via a digital radio broadcast channel.

21. A server device according to claim 20, further comprising queuing means for queuing said data stream with said received data in chronological order.

22. A server device according to claim 20, wherein said gateway means is configured to encrypt said received data using security parameters.

23. A server device according to claim 20, wherein said server device is configured to assign said mobile subscriber identity to a mobile device in response to a registration request.

24. A server device according to claim 23, wherein said server device is configured to assign a public user address in response to said registration request.

25. A server device according to claim 24, wherein said public user address comprises one of an IP address and an email address.

26. A server device according to claim 24, further comprising storing means for storing a table linking an assigned public user address to said assigned mobile subscriber identity.

27. A server device according to claim 21, further comprising deleting means for deleting said received data from a queued data stream in response to receipt of a recall request.

28. A server device according to claim 20, wherein said received data comprise an email content, wherein said adding means is configured to encapsulate said received email content into a radio broadcast packet, and wherein a message identity is added to a header of said radio broadcast packet.

29. A server device according to claim 20, wherein said received data comprise an IP packet, wherein said adding means is configured to encapsulate said received IP packet into a radio broadcast packet, and wherein a message identity is added to a header of said radio broadcast packet.

30. A server device according to claim 28, wherein said message identity is derived from a temporary mobile subscriber identity.

31. A server device according to claim 20, wherein said gateway means are configured to reject said received data, if a predetermined maximum data size is exceeded.

32. A server device according to claim 20, further comprising firewall means for filtering said received data so as to adhere to predetermined subscription parameters.

33. A server device according to claim 20, further comprising security server means for enabling exchange of security parameters with a mobile device.

34. A server device according to claim 33, wherein said parameter exchange is based on a SyncML protocol.

35. A server device according to claim 33, wherein said security parameters comprise at least one of a mobile subscriber identity and a ciphering key.

36. A server device according to claim 33, further comprising a security database for storing security parameters.

37. A server device according to claim 36, wherein said stored security parameters comprise initial security parameters and temporary security parameters.

38. A server device according to claim 37, wherein authentication for connection setup to said security server means is based on said initial security parameters.

39. A server device according to claim 37, wherein said security server means is configured to generate and store new temporary security parameters in response to a successful connection setup by said mobile device.

40. A server device according to claim 36, wherein said security server means is configured to delete said stored security parameters if a predetermined lifetime without successful connection setup has passed.

41. A gateway device for providing a connection between a cellular network and a digital radio broadcast domain, said gateway device being configured to encrypt data received from said cellular network to be forwarded to a mobile device, and to forward said encrypted data to said digital radio broadcast domain based on a conditional access scheme.

42. A gateway device according to claim 41, wherein said conditional access scheme defines a predetermined offline time during which said mobile device has not been in a coverage area of said cellular network, and wherein data forwarding is started after expiry of said offline time.

43. A gateway device according to claim 41, wherein said gateway device is configured to trigger a recall request towards said digital radio broadcast domain if it is detected that said mobile device is in a coverage area of said cellular network.

44. A gateway device according to claim 43, wherein said gateway device is configured to detect, based on a subscriber database query, whether said mobile device is in the coverage area.

45. A system for providing data services to mobile devices via a radio broadcast channel, said system comprising:
a cellular receiver device for receiving data from a data source, said cellular receiving device comprising cellular receiving means for enabling receipt of said data from a cellular network domain, and radio broadcast access means for providing conditional access to a digital radio broadcast data channel to enable receipt of said data via said digital radio broadcast data channel;
a server device for providing a data service to a mobile device, said server device comprising gateway means for receiving data from an external data source and for mapping a destination address of received data to a mobile subscriber identity, and adding means for adding said mobile subscriber identity to said received data, and for putting said received data with said mobile subscriber identity to a data stream to be broadcast via a digital radio broadcast channel; and
a gateway device for providing a connection between a cellular network and a digital radio broadcast domain, said gateway device being configured to encrypt data received from said cellular network to be forwarded to a mobile device, and to forward said encrypted data to said digital radio broadcast domain based on a conditional access scheme.

46. A method of transmitting data to a mobile device, said method comprising the steps of:
encrypting data to be forwarded; and
forwarding said data to a digital radio broadcast domain based on a conditional access scheme.

47. A method according to claim 46, wherein said conditional access scheme defines a predetermined offline time during which said mobile device has not been in the coverage area of a cellular network, wherein said data forwarding is started after expiry of said offline time.

48. A method of receiving data at a mobile device, said method comprising the step of:
providing a conditional access to a digital radio broadcast data channel to enable receipt of said data via said digital radio broadcast data channel; and
receiving said data.

49. A method according to claim 48, wherein said conditional access is provided by at least one of a ciphering function and an access function.

50. A computer program embodied on a computer readable medium, said computer program controlling one of a server device and a gateway device to perform the steps of:
encrypting data to be forwarded; and
forwarding said data to a digital radio broadcast domain based upon a conditional access scheme.

51. A computer program embodied on a computer readable medium, said computer program controlling a mobile device to transmit data by performing the steps of:
providing a conditional access to a digital radio broadcast data channel to enable receipt of said data via said digital radio broadcast data channel; and
receiving said data.
